(19) United States
(12) Patent Application Publication
(10) Pub. No.: US 2008/0028692 A1
(43) Pub. Date: Feb. 7, 2008

(54) Cemetery memorial with integrated flower vase

(76) Inventor: Armando F. Segura, Miami, FL (US)

Correspondence Address: JOHN H. FARO, ESQ.;FARO & ASSOCIATES, SUITE 1100, 44 WEST FLAGLER STREET, MIAMI, FL, 33130, US

(21) Appl. No.: 11/504,202

(22) Filed: Aug. 15, 2006

Related U.S. Application Data
(63) Continuation-in-part of application No. 10/707,899, filed on Jan. 22, 2004, now abandoned.

(51) Int. Cl. E04H 13/00; A01G 5/00; G09F 19/00

(52) U.S. Cl. 52/103; 40/124.5; 47/41.01; 47/41.1

(57) ABSTRACT

A modular system for generation of acetylene gas, in a reactor suitable for the controlled reaction of calcium carbide and water, is disclosed. In this system, a self-container reactor module is provided which is suitable for coupling to an acetylene gas reservoir. In one of the preferred embodiments of this invention, this reactor module can include a primary and a secondary charge of calcium carbide, and a stoichiometric excess of water. Acetylene gas is formed by initial contact of a primary calcium carbide charge with water in the reactor reservoir. Upon essentially complete reaction of the primary charge and the water in the reservoir, the pressure within the reactor is monitored, as such gas is drawn off to fuel the operation of an internal combustion engine. Where such pressure drops to, or below a pre-determined level, a secondary charge of calcium carbide is contacted with the remaining water in the reactor reservoir, so as to prevent interruption in the fueling of the internal combustion engine. These modules can also be “daisy chained” together, and thereafter sequentially activated, to provide essentially continuous operation of an internal combustion engine.

### BACKGROUND OF THE INVENTION

1. Field of the Invention

The present invention relates to cemetery memorials. More specifically, this invention relates to a cemetery memorial with a built in flower vase, which can be stored within a compartment of the memorial when not is use.

2. Prior Art

The use of cemetery grave markers, tombstones and the like (“cemetery memorials”) to adorn and mark gravesites is wellknown. These cemetery memorials can include elaborate crypts, sculptures and other similar adornments. More recently, these cemetery memorials have become substantial more subtle and tasteful, often comprising a simple slab of marble having an inscription, placed horizontally on a grave site. Typically, such memorials also have one or more compartments for placement of memorabilia and/or flowers. U.S. Pub. No. 2005/0126058 (Pub. Date Jun. 16, 2005, by Rojdev et al) is representative of this more contemporary style of monument—which is herein incorporated by reference in its entirety. In brief, the Rojdev memorial concept comprises an essentially hollow, rectangular marble base, which is place on the grave site, in the horizontal position. This Rojdev memorial includes a number of compartments accessible from the face surface of the marble slab. These compartments can be used to store memorabilia of the deceased, or offerings by his survivors, and/or flowers. The integration of these compartments, within the face surface of the marble slab of a cemetery memorial, has the reported advantage of minimizing clutter on the grave site, and the elimination of theft of, for example, vases and urns that are often used to adorn the memorial on the grave site. Additional examples of this integration of a receptacle/compartment within a grave stone are shown in U.S. Pat. No. 4,722,160 (to Davis—issued Feb. 2, 1998); U.S. Pat. No. 6,088,955 (to Nelson et al—issued Jul. 18, 2000); and Pub. No. 2002/0007601 (to Kachigian—Pub. Date Jan. 24, 2002)—which are herein incorporated by reference in their entirety.

The problem of vandalism and theft, particularly of items associated with a grave marker, such as items which can be readily displaced or removed, cannot be underestimated. For example, flower vases are a particular favorite of vandals and thieves because they are easy to remove from the grave site, and are virtually untraceable. Thus, these simple items can be resold and reused without detection or consequence. Accordingly, there continues to exist a need to provide a cemetery memorial, which includes one or more integrated compartments, particularly compartments that can both serve a flower holder or a vase for a flower offerings, that can be stored within the memorial when not in use. Such integration should also include means associated with the holder or vase which discourages theft, and is yet tasteful and respectful of the memorial.

### OBJECTS OF THE INVENTION

It is the object of this invention to remedy the above as well as related deficiencies in the prior art.

More specifically, it is the principle of object of this invention to provide an assembly comprise an assembly, in the form of an accessible compartment, and a vase within such compartment, that can be integrated with a cemetery memorial.

It is another object of this invention to provide an assembly, which includes a flower vase, which is both structurally and cosmetically compatible with a cemetery memorial, and which both facilitates the mounting of such vase on the memorial; and, thereafter, the storage thereof within the memorial, when no longer in use.

It is still yet another object of the invention to provide an assembly for housing a flower vase, wherein the vase can include permanent and distinctive indicia, in the form of a picture, or serial number, and/or a grave site address, to permit its ready identification, and thereby discourage the theft of the vase from the memorial.

It is a further object of this invention to provide an assembly for housing a flower vase, wherein such assemble includes a storage compartment having an open end and the closed end, and means for engagement of the open end of such storage compartment with the base of the vase.

Additional objects of this invention include means for discouraging the theft of a flower vase from a cemetery memorial.

### SUMMARY OF THE INVENTION

The above and related objects are achieved by providing an assembly having an accessible storage compartment for a vase, and a vase, wherein such assembly can be readily integrated within a cemetery memorial. In the preferred embodiments of this invention, the storage compartment is complimentary in overall dimension to the shape of the vase, so as to allow for storage of the vase within the compartment of the assembly, when not in use; and, for withdrawal of the vase from the compartment, and mounting thereof on the open end of the storage compartment, so as to accommodate the placement of flowers therein. The overall structure and dimensions of this storage compartment are adapted for placement and mounting within a hole in a marble slab of a cemetery memorial. In the preferred embodiment of this invention, the open end of the storage compartment includes a decorative flange for the flush mounting of the assembly to the surface of the marble face of the memorial.

In the context of this invention, the vase of this assembly can include a plaque containing certain indicia to identify it, as belonging to a specific cemetery memorial or grave site, and, preferable, include a likeness of the individual interred within the grave site. The likeness can prepared by applying a photo resist to a copper substrate, reproducing the likeness of the individual, by standard photographic imaging techniques, onto the photo resist and, thereafter, sealing the photographic reproduction of the likeness of the interred individual, on the copper substrate, with a clear ceramic glaze. The copper substrate can be permanently affixed on the backside thereof to the body of the vase, by adhesives and/or conventional metal working techniques.

### BRIEF DESCRIPTION OF DRAWINGS

FIG. 1 is a perspective view of a cemetery memorial having integrated storage compartments flush mounted on the face of the memorial.

FIG. 2 is an enlarged perspective view of the flush mounted assembly of FIG. 1, with the vase of such assembly being stored within the assembly, and viewed directly form above.

FIG. 3 is an enlarged perspective view of the flush mounted assembly of FIG. 1, with the vase of such assembly being in the deployed position and viewed from the side.

FIG. 4 is a diagrammatic view of the flower vase of FIG. 3, when viewed from the front.

FIG. 5 is a diagrammatic view of the flower vase of FIG. 3, when viewed from the side.

FIG. 6 is a diagrammatic view of the open end of the flange of the storage compartment of the flush mounted assembly of FIG. 1, when viewed from above.

FIG. 7 is a cross-sectional, diagrammatic view of the open end of the flange of the storage compartment of the flush mounted assembly of FIG. 6.

### DETAILED DESCRIPTION OF THE INVENTION INCLUDING PREFERRED EMBODIMENTS

The basic concept of this invention is directed to an assembly (8) which can be used in combination with a cemetery memorial (10), specifically, a memorial which is compatible with the inclusion of an accessible compartment for housing a flower vase or other storage related items. FIG. 1 illustrates one of the preferred embodiments of a cemetery memorial (10) of this invention having integrated therein an accessible storage compartment (12) and complimentary flower vase (14). As is apparent from FIG. 1, a hole is first cut into the face of the marble slab (16) of the memorial (10), to allow for the insertion of an assembly (8) comprising a vase (14) and an accessible storage compartment for the vase (12). The assembly (8) is affixed to the marble face (16) of the memorial (10) by bonding a flange (13) of the assembly (8) to the marble. In FIG. 1, the vase (14) is placed in an inverted position within the accessible storage compartment (12), and thus is not visible, except for the base (14″) portion thereof, which is in sealing engagement with the open end (18) of the storage compartment (12) of the assembly (8).

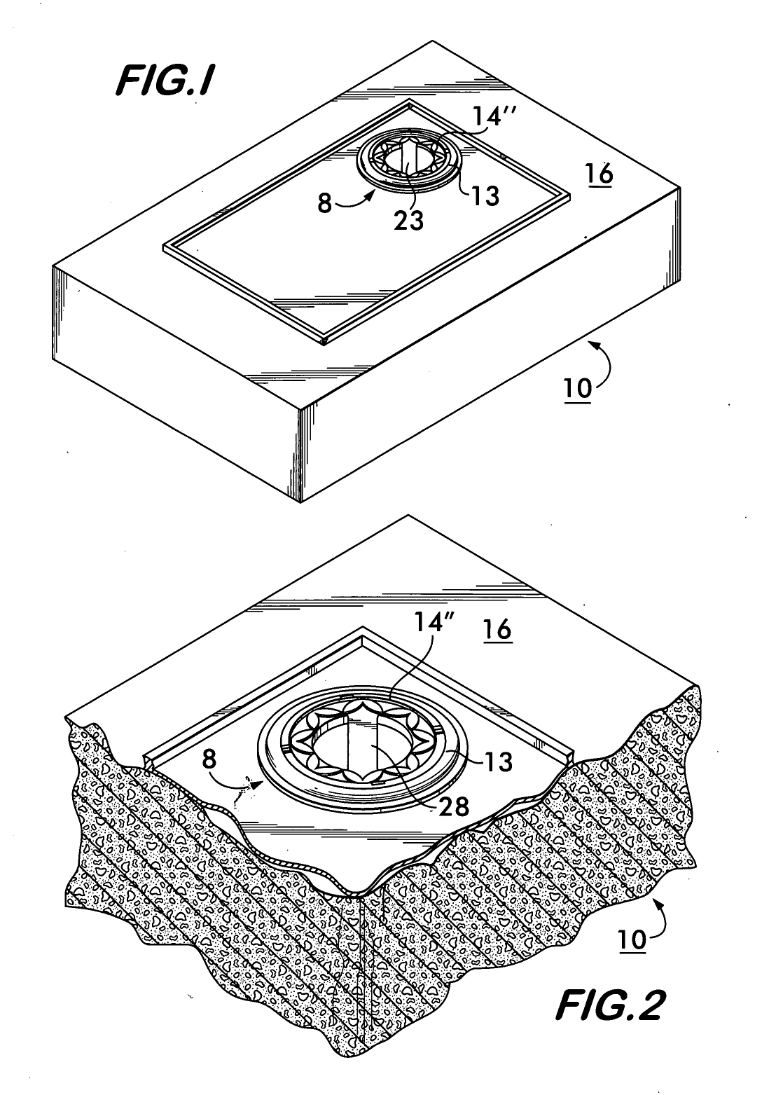

FIG. 2 depicts this module of FIG. 1 is greater detail. As shown in FIG. 2, this assembly (8), once installed in the face of the marble slab (16) of the memorial (10), is essentially flush with the marble surface (16) thereof. This assembly (8) is seated within an opening (20) in this slab and essentially permanently bonded thereto with adhesive. In the depiction of the assembly (8) shown in FIG. 2, the vase (14) is stored within the assembly (8) in the inverted position, specifically, with open end (14′) of the vase (14) facing downward and into the closed end (12′) a storage compartment (12), and, thus, only the closed end or base (14″) of the vase (14) is visible in FIG. 2 from above. The closed end (14″) of the vase (14) is provided with a retractable handle (28), which permits removal of the vase (14) from the storage compartment (12) and its installation in an upright position on the open end (12′) of the storage compartment (12).

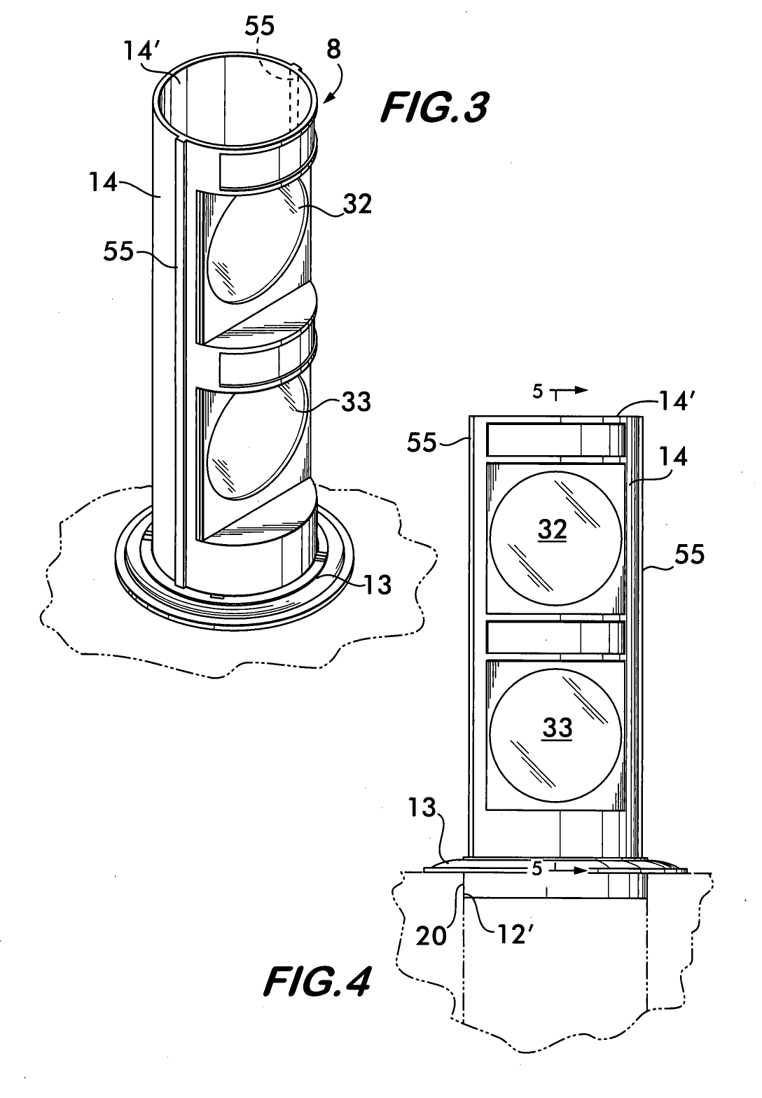

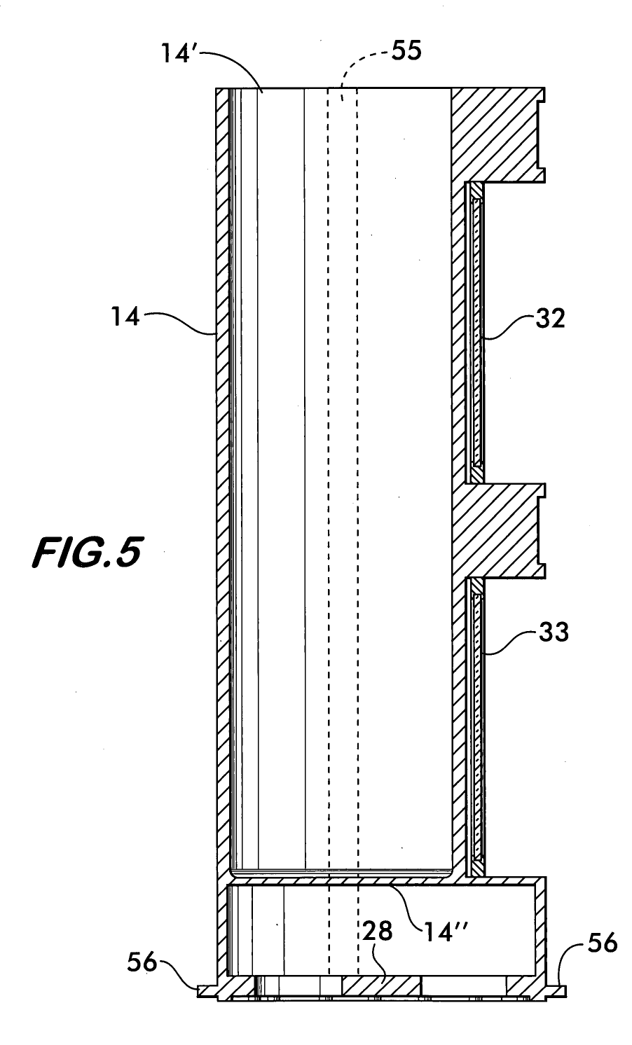

FIG. 3 depicts the vase (14) an upright position, and affixed to the open end (12′) of the storage compartment (12) of the assembly (8). The base (14″) of the vase (14), and the open end (12′) of the storage compartment (14), include complimentary means (e.g. bayonet-like mechanical means, such as are found on 35 mm cameras with interchangeable lens) (30) for mounting the vase (14′, 14″) on the open end (12′) of the storage compartment (12). The means for engagement of the base (14″) of vase (14) to the open end (12′) of the storage compartment (12) are discussed in greater detail in reference to FIGS. 5 & 6.

FIG. 4 provides a diagrammatic illustration of the vase shown in FIG. 3, when viewed from the front. In this depiction, the vase (14) is shown to include two frames (32, 33) for mounting a photographic reproduction of an individual interred at the grave site. These frames (32, 33) are recessed into the body of the vase (14), so as to protect them from damage as the vase is withdrawn from, and, thereafter, reinserted into the storage compartment of the assembly.

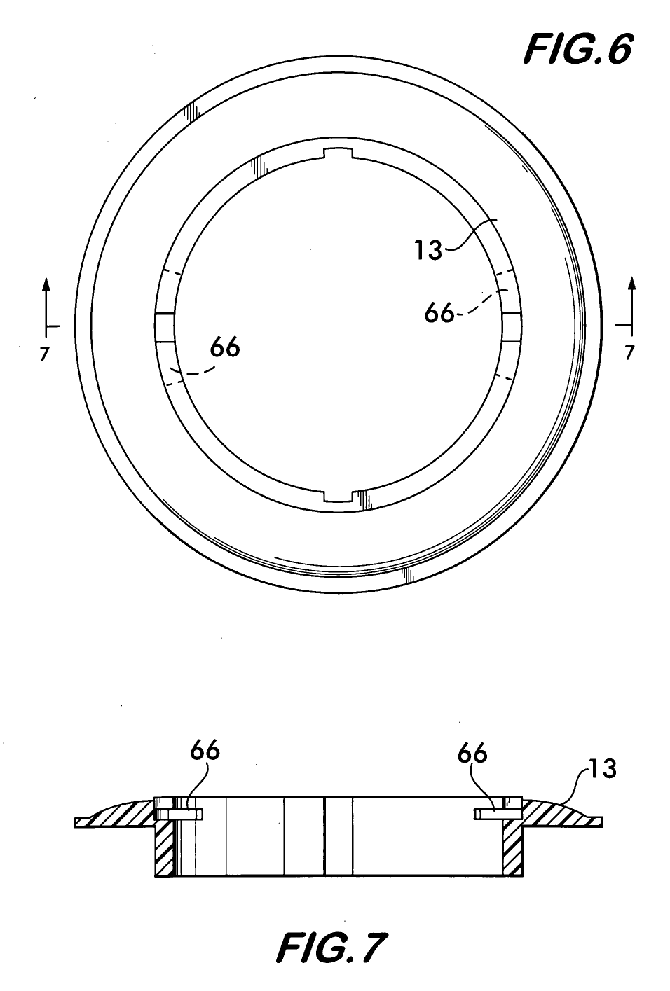

FIG. 5 provides a diagrammatic illustration of the vase (14) as shown in FIG. 3, when viewed from the side. In this depiction, the recessed frames (33, 34) are shown to occupy the portion of the vase (14), which is visible upon the withdrawal and mounting of the vase on the open end (12′) of the storage compartment (12). In addition, FIG. 5 illustrates the placement of periodic radiating extensions (55) positioned around the base (14″) of the vase (14). These projections (55) are designed to compliment and interlock with a ring-like aperture (66), such as illustrated in FIGS. 6 & 7, which have been formed with open end (12′) of the storage compartment (12).

As indicated previously, in the description of FIG. 2, and in the description of FIG. 3, the these radiating projections (55) on the base (14″) of the vase (14) interlock with the ring-like aperture (66) formed within the open end (12′) of the storage compartment (12), which in the first instance (FIG. 2) provide for sealing engagement of the closed end or base of the vase (14″), in the inverted position, with the open end (12′) of the storage compartment (12); and, in the latter instance (FIG. 3), for the mounting of the closed end or base of the vase (14″), in the upright position, on the open end (12′) of the storage compartment (12).

In practice, the assembly (8) of this invention can be incorporated with a cemetery memorial (10) prior to its placement on a grave site; or, an existing cemetery memorial modified, subsequent to installation, by simply drilling a hole in face of the memorial and mounting the assembly within such hole. In addition to the pictorial information, that is included within the frames (23, 23′) provided on the vase (14), the bottom of the vase (14″) can include a serial number or grave site information (not shown) to identify the assembly as belonging to a certain grave site.

Additional modifications and enhancements to the foregoing specific embodiments are clearly within the contemplation of one skilled in the art; and, the foregoing is, thus, not intended to fully delineate the scope of protection to be accorded to the inventor, which is set forth in the following set of claims.

What is claimed is:

1. In an improved assembly for holding a flower display on a cemetery memorial, said assembly including a compartment integrated within said memorial and accessible from the exposed face thereof, wherein the improvement comprises:
A. A storage compartment having a housing comprising an elongate compartment and flange, on an open end thereof of said compartment, for mounting said compartment to said face surface of a cemetery memorial, said open end of said compartment having means for mechanical attachment, and disengagement, with complimentary mechanical means associated with a vase;
B. A vase having an overall exterior dimension consistent with storage and withdrawal of said vase from within said elongate compartment, said vase being further provided with mechanical means arranged around the base of said vase, which are complimentary to said mechanical means formed within said opened end of said storage compartment for
(1) sealing engagement of said based of said vase, with said open end of said storage compartment, when said vase is in an inverted position; and
(2) fixed engagement and mounting of said base of said vase, with said open end of said storage compartment, when said vase in an upright and flower receiving position.

2. The improvement of claim 1, wherein said vase of said assembly includes means for receiving and mounting a photographic reproduction on said exterior surface of said vase.

3. The improvement of claim 1, wherein said vase of said assembly includes a plurality of means for guiding the placement and withdrawal of said vase with said storage compartment, so as to minimize abrasion and damage to the vase upon its insertion and withdrawal from said compartment.

4. The improvement of claim 1, wherein said vase includes permanent indicia inscribed on the base thereof to identify the grave site to which said vase belongs.

5. The improvement of claim 1, wherein said vase storage compartment includes means for mounting and attachment to a surface of cemetery memorial.

6. In an improved cemetery memorial which includes housing fabricated from a weather resistant material, such as marble or stone, a face surface associated with said housing for inscription of information relating to the deceased individual interred at a grave site and one or more compartments, accessible form said face surface for storing of memorabilia and/or a flower holder, such as a vase, wherein the improvement comprising:
A. A storage compartment having a housing comprising an elongate compartment and flange, on an open end thereof of said compartment, for mounting said compartment to said face surface of a cemetery memorial, said open end of said compartment having means for mechanical attachment, and disengagement, with complimentary mechanical means associated with a vase;
B. A vase having an overall exterior dimension consistent with storage and withdrawal of said vase from within said elongate compartment, said vase being further provided with mechanical means arranged around the base of said vase, which are complimentary to said mechanical means formed within said opened end of said storage compartment for
(1) sealing engagement of said based of said vase, with said open end of said storage compartment, when said vase is in an inverted position; and
(2) fixed engagement and mounting of said base of said vase, with said open end of said storage compartment, when said vase in an upright and flower receiving position.

7. The improvement of claim 6, wherein said vase of said assembly includes means for receiving and mounting a photographic reproduction on said exterior surface of said vase.

8. The improvement of claim 6, wherein said vase of said assembly includes a plurality of means for guiding the placement and withdrawal of said vase with said storage compartment, so as to minimize abrasion and damage to the vase upon its insertion and withdrawal from said compartment.

9. The improvement of claim 6, wherein said vase includes permanent indicia inscribed on the base thereof to identify the grave site to which said vase belongs.

10. The improvement of claim 6, wherein said vase storage compartment includes means for mounting and attachment to a surface of cemetery memorial.
